(19) United States
(12) Patent Application Publication
(10) Pub. No.: US 2026/0340412 A1
(43) Pub. Date: Oct. 29, 2026

(54) KNOWLEDGE DISTILLED EXOGENEOUS LARGE LANGUAGE MODEL FINETUNING

(71) Applicant: Dell Products L.P., Round Rock, TX (US)

(72) Inventors: Chris Lazar, Round Rock, TX (US); Varun Sriram Kausika, Round Rock, TX (US); Trevor Moos, Austin, TX (US); John Thomas Flume, Austin, TX (US); Saurabh Jha, Leander, TX (US)

(21) Appl. No.: 19/189,817

(22) Filed: Apr. 25, 2025

(51) Int. Cl. G06N 3/096; G06N 3/042

(52) U.S. Cl. CPC G06N 3/096; G06N 3/042

(57) ABSTRACT

Techniques described herein relate to a method for processing queries. The method includes obtaining a query from a client, wherein the query is associated with a target domain; generating an intermediate result using a base large language model (LLM); providing the intermediate result and the query to a trained LLM, wherein the trained LLM is associated with the target domain and is trained using the base LLM; generating, by the trained LLM, a final response based on the intermediate result and the query; and providing the final response to the client.

### BACKGROUND

Users may send queries that require the use of a large language model (LLM). Conventional LLMs that may be used to respond to such queries are typically trained across a wide set of subject matter areas and, as such, they tend to not perform at the required level of accuracy when faced with certain specific subject matter (or domain specific) queries.

### BRIEF DESCRIPTION OF DRAWINGS

Certain embodiments disclosed herein will be described with reference to the accompanying drawings. However, the accompanying drawings illustrate only certain aspects or implementations of one or more embodiments disclosed herein by way of example and are not meant to limit the scope of the claims.

FIG. 1.1 shows a diagram of a system in accordance with one or more embodiments disclosed herein.

FIG. 1.2 shows a diagram of a manager in accordance with one or more embodiments disclosed herein.

FIG. 2 shows a flowchart for a method for training a smaller large language model (LLM) using the input and output of a larger base LLM in accordance with one or more embodiments disclosed herein.

FIG. 3 shows a flowchart for a method for generating a final answer using the smaller LLM in accordance with one or more embodiments disclosed herein.

FIG. 4 shows a computing system in accordance with one or more embodiments disclosed herein.

### DETAILED DESCRIPTION

Entities often use language models for tasks related to target domains. In many circumstances, entities utilize large language models (LLMs) to perform those tasks. As tasks get more specific and targeted, limitations within the utilized LLMs require the entities to fine tune or utilize alternate LLMs to efficiently perform the tasks. Such delays and additional work, often requiring re-training or modification of the LLM, are time consuming and resource intensive. This inefficiency prohibits entities from performing the specific tasks in any meaningful manner.

In certain scenarios, an entity, such as a corporation, client, or user, may wish to receive a response to a query related to one or more target domains. The traditional approach requires parsing through local data related to the specific area to manually generate a response. Alternate traditional approaches include feeding the local data related to the specific areas into an LLM and, after parsing, the LLM generates a response. In this alternative traditional approach, generic, off-the-shelf LLMs inherently struggle to generate responses using the target domains due to limitations within their training methods and/or training data. Further, such target domains may include proprietary or sensitive information that may not be suitable to train open-source or generic LLMs. Even further, many generic, off-the-shelf LLMs include their own restrictions on modification or fine tuning that may be required to efficiently respond to queries related to the target domains, thereby hampering the ability of for these types of LLMs to be used to effectively service queries for domain specific queries.

For the least the reasons discussed above, a different approach is needed to address these challenges and improve generic LLM functionality to respond to queries related to target domains. Embodiments disclosed herein relate to a method for processing queries for targeted domains. As a result of the processes described below, one or more embodiments disclosed herein advantageously ensures that queries related to targeted domains are efficiently processed without requiring significant modification or fine-tuning of a base, generic LLM.

The following described one or more embodiments.

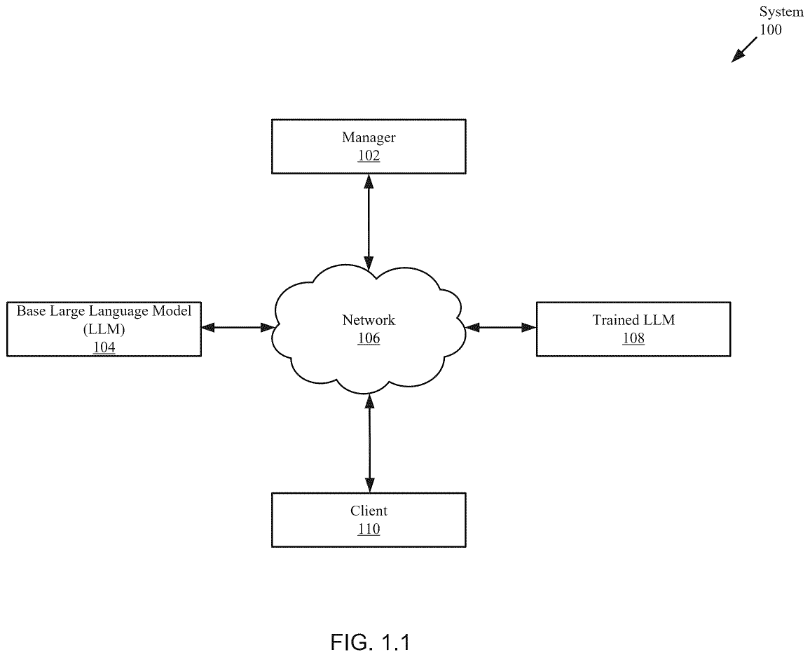

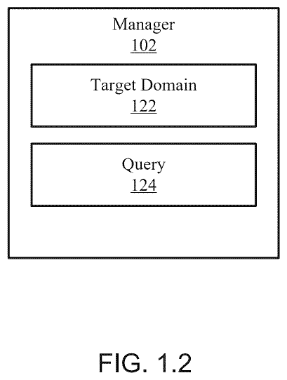

FIG. 1.1 shows a system in accordance with one or more embodiments. The system (100) may include a manager (102), a base LLM (104), a network (106), a trained LLM (108), and a client (110). The system (100) may include additional, fewer, and/or different components without departing from the scope described herein. Each component may be operably/operatively connected to any of the other components via any combination of wired and/or wireless connections. Each of these system components is described below.

In one or more embodiments, the manager (102), the base LLM (104), the trained LLM (108), and the client (110) may be operatively connected to one another through a network (106) (e.g., a local area network (LAN), a wide area network (WAN) such as the Internet, a mobile network, any other network type, or any other connection type not listed). Further, the network may encompass various interconnected, network-enabled subcomponents (or systems) (e.g., switches, routers, gateways, etc.) that may facilitate communications between the manager (102), the base LLM (104), and the trained LLM (108). Moreover, the manager (102), the base LLM (104), the trained LLM (108), and the client (110) may communicate with one another using any combination of wired and/or wireless communication protocols.

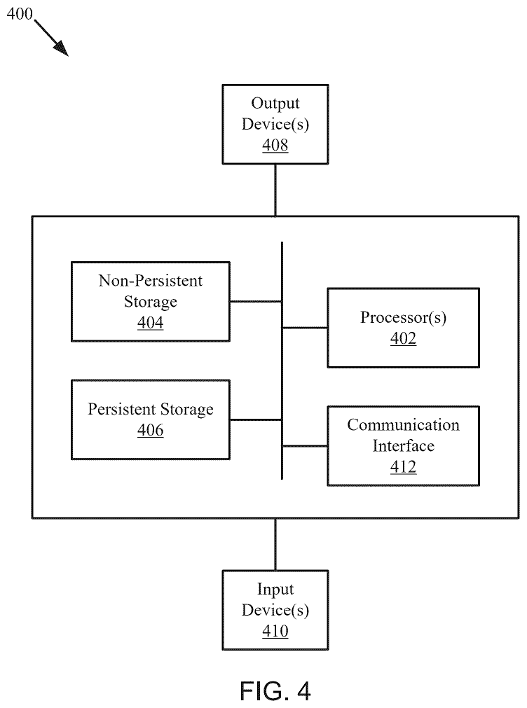

Turning now to the manager (102), the manager (102) may be a computing device (e.g., 400, FIG. 4) that manages (e.g., creates, monitors, facilitates, modifies, removes, receives, transmits, etc.), the base LLM (104), the trained LLM (106), and the client (110).

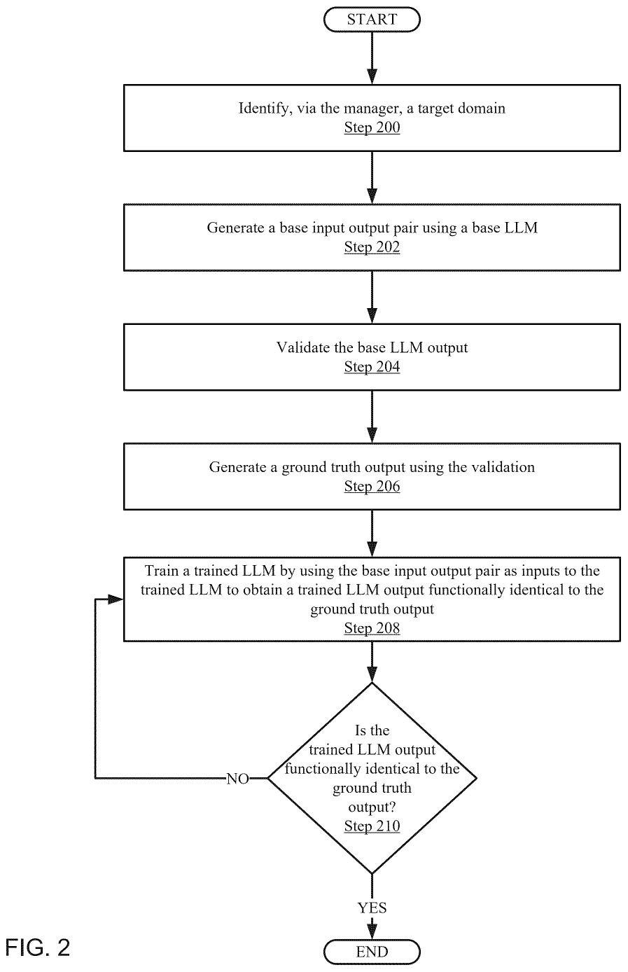

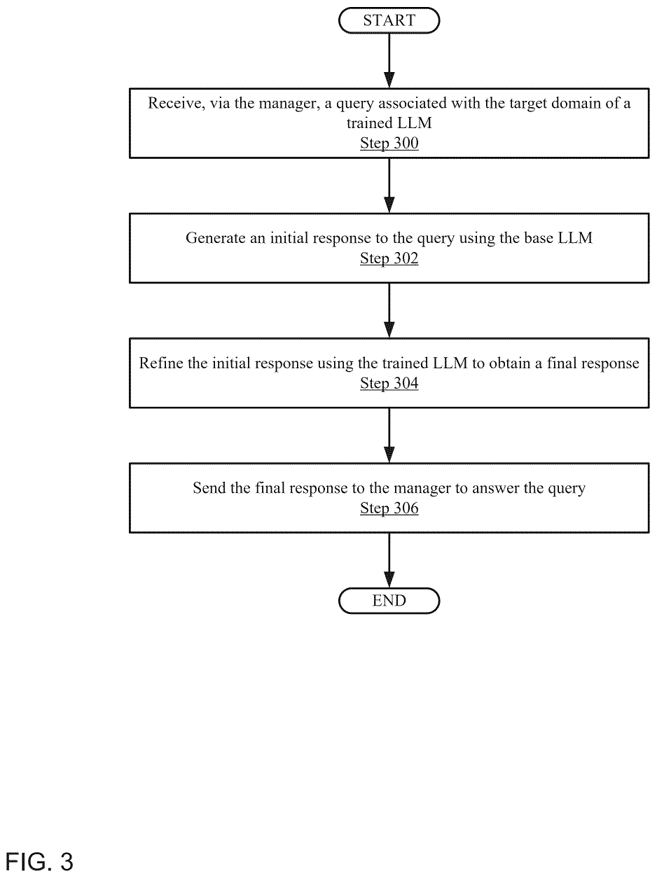

In one or more embodiments, the manager (102) may include the functionality to manage client queries, base LLM generated responses, and trained LLM generated responses. More specifically, the manger may include the functionality to receive queries and LLM generated responses, send LLM generated responses as an input to other LLMs, and send to clients LLM responses to queries by the client. As a non-limiting example, the manager (102) may send and receive queries from the client, send inputs to a multitude of LLMs (e.g., base LLM (104), trained LLM (106)), and receive generated outputs (e.g., responses to queries). In one or more embodiments, the manager (102) may also identify target areas (also referred to as target domains) associated with the queries and make determinations regarding the state of trained LLMs (106) associated with such target areas. The target areas are discussed in greater detail below. Additional details about the manager (102) are described in FIG. 1.2. One of ordinary skill will appreciate that the manager (102) may perform other functionalities without departing from the scope of the embodiments disclosed herein. In one or more embodiments, the manager (102) may be configured to perform all, or a portion, of the functionalities described in FIGS. 2 and 3. The manager (102) may be implemented using hardware (e.g., any number of integrated circuits for processing computer readable instructions), software (e.g., a computer program), or any combination thereof.

Turning now to the base LLM (104), the base LLM (104) may be a type of artificial intelligence model (or module) based on a deep learning algorithm that may be developed by a third-party. In one or more embodiments, the base LLM (104) may have developer restrictions that prevents other entities from modifying or further training the base LLM (104) for more specific and/or targeted tasks (or queries). In one or more embodiments, the base LLM (104) may be accessed via an application programming interface (API) for a fee and/or require monetary transactions to use. In one or more embodiments, the base LLM (104) may have at least four times as many computational parameters as the trained LLM (108). The base LLM (104) may be implemented using a software-as-a-service (SaaS). The base LLM (104) may be implemented using hardware (e.g., any number of integrated circuits for processing computer readable instructions), software (e.g., a computer program), or any combination thereof. The base LLM (104) may be implemented using other mechanisms without departing from the scope of the disclosure.

In one or more embodiments, the base LLM (104) may include the functionality to receive queries associated with target domains (described in FIG. 1.2), generate responses to the queries, and send both the queries and responses to the manager (102). In one or more embodiments, the base LLM (104) may be configured to perform all, or a portion, of the functionalities described in FIGS. 2 and 3. One of ordinary skill will appreciate that the base LLM (104) may perform other functionalities without departing from the scope of the embodiments disclosed herein.

Turning now to the trained LLM (108), the trained LLM (108) may be a type of artificial intelligence model or module based on a deep learning algorithm that may be developed by a third-party or may be developed in-house. In one or more embodiments, the trained LLM (108) may be via an application programming interface (API) and be a free, open-source LLM or may require monetary transactions to use. In one or more embodiments, the trained LLM (108) may be substantially smaller than the larger base LLM (104) (e.g., may have at least four times fewer computational parameters as compared to the larger base LLM (104)). The trained LLM (108) may be implemented using a SaaS. The trained LLM (108) may be implemented using hardware (e.g., any number of integrated circuits for processing computer readable instructions), software (e.g., a computer program), or any combination thereof. The trained LLM (108) may be implemented using other mechanisms without departing from the scope of the disclosure.

In one or more embodiments, the trained LLM (108) may include the functionality to be trained on base input-output pairs from the base LLM (104), ground truth outputs associated with the base input out pairs, receive queries associated with target domains, generate responses to the queries, and send the responses to the manager (102). In one or more embodiments, the trained LLM (108) may further include the functionality to refine the base LLM (104) responses to improve the accuracy of the LLM generated response. In one or more embodiments, the trained LLM (108) may be trained to emulate the generating methodology of the base LLM (104) using data distillation. Any known data distillation and LLM generating emulation may be used without departing from the scope of the disclosure. Further, the trained LLM (108) may optimize its generation by selectively routing and pruning the components used by the base LLM (104) during output generation. Said another way, the trained LLM (108) may achieve similar performance as the base LLM while maintaining a smaller size by only keeping the necessary pathways in the trained LLM (as opposed to all pathways in the trained LLM) for response generation. In one or more embodiments, the trained LLM (108) may be configured to perform all, or a portion, of the functionalities described in FIGS. 2 and 3. One of ordinary skill will appreciate that the trained LLM (108) may perform other functionalities without departing from the scope of the embodiments disclosed herein.

Turning now to the client (110), the client (110) may be physical or logical computing devices configured for hosting one or more workloads, or for providing a computing environment whereon workloads may be implemented. The client (110) may provide computing environments that are configured for, at least: (i) workload placement collaboration, (ii) computing resource (e.g., processing, storage/memory, virtualization, networking, etc.) exchange, and (iii) protecting workloads (including their applications and application data) of any size and scale. The client (110) may correspond to computing devices that one or more users use to interact with one or more components of the system (100). The client (110) may also be a user directly asking queries associated with a target domain or associated with the system. One of ordinary skill will appreciate that the client (110) may perform other functionalities without departing from the scope of the embodiments disclosed herein.

Turning to FIG. 1.2, FIG. 1.2 shows a diagram of a manager (102) in accordance with one or more embodiments disclosed herein. The manager (102) includes a target domain (122) and a query (124). One of ordinary skill in the art may appreciate that the manager (102) may include other components, not shown, without departing from the scope of the disclosure. Each of these components is described below.

Turning now to the target domain (122), the target domain (122) may be a focus area that narrows the search breadth of an LLM. The focus area may be any topic that requires specific answers and knowledge. In one or more embodiments, the target domain (122) may be used to train the trained LLM (108) to refine responses generated by the base LLM (104). As non-limiting examples, the target domain may be image generation or financial transactions. Further, in one or more embodiments, the target domain (122) may be an even smaller focus area such as a set of graphs or tables. As another non-limiting example, the target domain (122) may be a pair of graphs depicting collection datasets and closed transactions over fiscal weeks. In one or more embodiments, the target domain may be a focus area with heightened security requirements that cannot be used as training data for the base LLM (104). In one or more embodiments, the target domain may include proprietary or confidential information.

Turning now to the query (124), the query (124) may be a question sent by the client (110) associated with the target domain (122). One of ordinary skill in the art may appreciate that the query (124) may be sent by other components in the system without departing from the scope of the disclosure. In one or more embodiments, the query may be targeted to specific information within the target domain (122) that the base LLM (104) may not be able to effectively/accurately answer due to lacking access or training with respect to the specific information. Accordingly, the query may cause the base LLM (104) to generate inaccurate responses attempting to answer the query.

Turning to FIG. 2, FIG. 2 shows a flowchart for a method for training a smaller large language model (LLM) using the input and output of a larger base LLM in accordance with one or more embodiments disclosed herein. The method may be performed by, for example, the manager (102, FIG. 1.1). Other components in the system (100) may perform this method without departing from the scope of the disclosure. While this disclosure specifies a larger and smaller LLM, one of ordinary skill in the art may appreciate that any size LLM may be used without departing from the scope of this disclosure.

While the various steps in the flowchart shown in FIG. 2 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel. Further, one or more steps in FIG. 2 may be performed concurrently with one or more steps in FIG. 3.

In step 200, the manager (102) identifies (or obtains from the client or a user) a target domain (122). The target domain may be a broader topic area such or a specific dataset. The target domain may be identified using market trends, business practices, previous queries from clients, or any other event that triggers interest in a specific area. The target domain (122) may be a new domain, or a domain previously identified.

In step 202, the manager generates a base input-output pair using the base LLM (104). To do this, the manager directs the base LLM (104) to obtain initial inputs related to the target domain. As a non-limiting example, the initial input may be a query related to the target domain. In one or more embodiments, the manager may set a received query (e.g., a query sent by a client) as the initial input. After generating, or receiving, the initial input, the manager then sends the input to the base LLM to generate an output. After receiving the output from the base LLM, the manager then pairs the initial input and the generated output together to generate the base input-output pair.

In step 204, the manager validates the base input-output pair. The validation may involve gathering pre-verified answers for the initial inputs generated in step 200 and comparing the base LLM outputs to the pre-verified answers. In one or more embodiments, the base input-output pair is checked against a validation threshold to determine the degree of accuracy. In one or more embodiments, the pre-verified answers can be obtained via any known or later discovered methods. As a non-limiting example, the pre-verified answers may be submitted to the manager by authorized personnel in charge of training. Those skilled in the art will appreciate that other validation methods may be used to validate the base input-output pair.

In step 206, the manager generates ground truth outputs using the validation. If the base output of the base input-output pair is below the validation threshold (i.e., the output is not accurate as determined by the validation method), the ground truth output (i.e., an accurate output for the input) is generated. If the base output of the base input-output pair is above the validation threshold, the output is set as the ground truth and a new ground truth output is not generated. In one or more embodiments, ground truth outputs are objectively accurate responses to initial queries. In one or more embodiments, the ground truth outputs are base LLM outputs that are modified using the pre-verified answers. Alternatively, in one or more embodiments, the ground truth outputs are ground truths set as outputs by the manager (or a user interacting with the manager). As a non-limiting example, if the base LLM outputs are significantly wrong, the manager may choose to set the ground truth as an output and not modify the base LLM output.

In step 208, the manager trains the trained LLM (108) by using the base input-output pair as inputs to the trained LLM. The trained LLM outputs are iteratively refined until the outputs functionally match the ground truth output. This allows for the trained LLM to generate accurate responses using the methodology of the base LLM. In one or more embodiments, this training process ensures that knowledge distills between the base LLM and the trained LLM such that the trained LLM can effectively emulate the base LLM generation methodology. Further, in one or more embodiments, the trained element can be optimized by only engaging the pathways activated by the base LLM and pruning the remaining pathways to conserve computational resources.

In step 210, the manager makes a determination as to whether the trained LLM output is functionally identical to the ground truth output. Functionally identical refers to arriving at substantially the same answer (or within an acceptable margin of error). As a non-limiting example, if the ground truth output contains the number five and a positive reading, the trained LLM output will be functionally identical if it also contains the number five and a positive reading irrespective of syntax structure. In one or more embodiments, if the determination is YES, the method ends. In one or more embodiments, if the determination is NO, the method proceeds to step 208 and the trained LLM is further refined.

Turning to FIG. 3, FIG. 3 shows a flowchart for a method for generating a final answer using the smaller LLM in accordance with one or more embodiments disclosed herein. The method may be performed by, for example, the base LLM (104, FIG. 1.1). Other components in the system may perform this method without departing from the scope of the disclosure.

While the various steps in the flowchart show in FIG. 3 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel. Further, one or more steps in FIG. 3 may be performed concurrently with one or more steps in FIG. 2.

In step 300, the base LLM receives a query associated with the target domain of the trained LLM. In one or more embodiments, the query may be a request for information within the target domain, an analysis of an aspect within the target domain, or any other request associated with the target domain. As a non-limiting example, if the target domain is charted datasets relating to business transactions, a query could be a request to generate conclusions using the charts. In one or more embodiments, the manager may send the query to the base LLM. Other components, such as the client (FIG. 1.1, 110), may send the query to the base LLM without departing from the scope of the disclosure.

In step 302, the base LLM generates an initial response to the query. In one or more embodiments, the base LLM generates the initial response through an API connected to an offsite server which processes the query. Any known or later discovered method for LLM based response generation may be used without departing from the scope of the disclosure.

In step 304, the trained LLM refines the initial response to obtain a final response to the query. More specifically, the query and the initial response are provided the trained LLM, which then proceeds to use the query and the initial response as inputs to generate a final response to the query. In one or more embodiments, the trained LLM may be appended to the final compute layers of the base LLM to add additional refinement layers to the response generation process. In one or more embodiments, the trained LLM may be a secondary, independent step that receives the initial response generated by the base LLM and generates the final response based on the initial response and the query. In yet another embodiment, the trained LLM may generate the final response using only the initial response as the input. In step 306, the trained LLM sends the final response to the manager in response to the query.

In one or more embodiments disclosed herein, the method ends following step 306.

To further clarify aspects of embodiments disclosed herein, a non-limiting example is provided below.

### Example

Consider a scenario in which a client (FIG. 1, 110) asks questions associated with two charts. The first chart depicts business transaction precents over a series of weeks. The second chart depicts collections related to the business transactions.

To efficiently answer the client's questions, the manager (FIG. 1.2, 102) first determines that a trained LLM (FIG. 1.1, 108) does not exist. Following the determination, the manager then identifies the target domain based on the questions. In this example, the target domain is collections and business transactions. The manager then sends the initial client query and the underlying data associated with the two charts to a base LLM (e.g., Llama™ LLM, FIG. 1.1, 104; Llama is a trademark of Meta Platforms, Inc.) to generate a base LLM output. After receiving the initial output, the manager packages the initial client query and the base LLM output into a base input-output pair. The base input-output pair is the base LLM query and query response. Further, this base input-output pair serves as the input to the trained LLM during the initialization phase.

After generating the base input-output pair, the manager validates the base LLM output. The manager validates the base LLM output by comparing the accuracy of the base LLM output to a ground truth. The ground truth is associated with the underlying data comprising the two charts and is factually verifiable. As a further example, if the first chart spans 12 weeks, a ground truth to a query related to the total number of weeks in the chart would be 12 weeks. Based on the validation, the manager determines that the base LLM output is not accurate and generates a ground truth output to pair with the base input-output pair. As used herein, the ground truth output is a corrected output associated with the base input-output pair that is corrected using the ground truth.

The manager then trains the trained LLM by sending the base input-output pair and the ground truth output as inputs. The purpose for the training is to obtain a smaller model that can generate an accurate response using similar pathways and methodologies as the base LLM. Accordingly, the smaller LLM inherits task-relevant knowledge from the base LLM, here Llama™, through knowledge distillation processes. Further, the training comprises optimized routing and pruning of the critical pathways in the base LLM such that the overall computational demand is decreased with regards to the trained LLM. Additional training methods are used to ensure that the trained LLM generates accurate responses using the same generation methods and pathways as the base LLM.

The manager receives a trained LLM output from the trained LLM and makes a determination as to whether the trained LLM output is functionally identical to the ground truth output. The manger determines that the trained LLM output is not functionally identical and iterates the training process (generating a trained LLM output via the above stated inputs) until the trained LLM output is functionally identical to the ground truth output. Through this training, the manager obtains a trained LLM for the target domain associated with the client's query.

After obtaining the trained LLM, the manager once again sends the client query to the base LLM. Here, the base LLM is a Llama™ base model. The base LLM generates an initial response to the query. The manager, after receiving the initial response, sends the initial response to the trained LLM. Here, the trained LLM is a 0.5 billion parameter LLM model that is approximately 8 times smaller than the base model (which has approximately 4 billion parameters). Upon receiving the initial response from the manager, the trained LLM refines the initial response to generate a final response. The manager then sends the final response to the client in response to their query.

In a real-world proof of concept experiment, the client sent 30 queries related to the two charts. Using the above method, the example embodiment disclosed accurately answered 27 out of the 30 queries while the base LLM (e.g., Llama™) alone only accurately answered 15 out of the 30 queries. Accordingly, the embodiment resulted in close to double the performance of the standalone base LLM.

### End of Example

Embodiments of the disclosure may be implemented using computing devices. FIG. 4 shows a diagram of a computing device (400) in accordance with one or more embodiments. The computing device (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (408) (e.g., Bluetooth interface, infrared interface, network interface, optical interface, etc.), input devices (410), output devices (408), and numerous other elements (not shown) and functionalities. Each of these components is described below.

In one embodiment, the computer processor(s) (402) may be an integrated circuit for processing instructions. For example, the computer processor(s) (402) may be one or more cores or micro-cores of a processor. The computing device (400) may also include one or more input devices (410), such as a touchscreen, keyboard, mouse, microphone, touchpad, electronic pen, or any other type of input device. The communication interface (408) may include an integrated circuit for connecting the computing device (400) to a network (not shown) (e.g., a local area network (LAN), a wide area network (WAN) such as the Internet, mobile network, or any other type of network) and/or to another device, such as another computing device.

In one embodiment, the computing device (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) (408, 410) may be locally or remotely connected to the computer processor(s) (402), non-persistent storage (404), and persistent storage (406). Many diverse types of computing devices exist, and the aforementioned input and output device(s) (410, 408) may take other forms.

Specific embodiments are described above with reference to the accompanying figures. In the above detailed description of the embodiments disclosed herein, numerous specific details are set forth in order to provide a more thorough understanding of one or more embodiments disclosed herein. However, it will be apparent to one of ordinary skill in the art that the one or more embodiments disclosed herein may be practiced without these specific details. In other instances, well-known features have not been described in detail to avoid unnecessarily complicating the description.

In the above description of the figures, any component described with regard to a figure, in various embodiments disclosed herein, may be equivalent to one or more like named components described with regard to any other figure. For brevity, descriptions of these components are not repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase “operatively connected” may refer to any direct connection (e.g., wired directly between two devices or components) or indirect connection (e.g., wired and/or wireless connections between any number of devices or components connecting the operatively clients). Thus, any path through which information may travel may be considered an operative connection.

Software instructions in the form of computer readable program code to perform embodiments described herein may be stored, in whole or in part, temporarily or permanently, on a non-transitory computer readable medium such as a CD, DVD, storage device, a diskette, a tape, flash memory, physical memory, or any other physical computer readable storage medium. Specifically, the software instructions may correspond to computer readable program code that, when executed by a processor(s), is configured to perform one or more embodiments described herein.

While the disclosure has been described above with respect to a limited number of embodiments, those skilled in the art, having the benefit of this disclosure, will appreciate that other embodiments can be devised which do not depart from the scope as disclosed herein. Accordingly, the scope of the disclosure should be limited only by the attached claims.

What is claimed is:

1. A method for processing queries, the method comprising:
obtaining a query from a client, wherein the query is associated with a target domain;
generating an intermediate result using a base Large Language Model (LLM);
providing the intermediate result and the query to a trained LLM, wherein the trained LLM is associated with the target domain and is trained using the base LLM;
generating, by the trained LLM, a final response based on the intermediate result and the query; and
providing the final response to the client.

2. The method of claim 1, further comprising:
prior to obtaining the query, training a second LLM using the base LLM to obtain the trained LLM, wherein training the second LLM comprises:
validating a set of input-output pairs to obtain validation results, wherein for each input in an input-output pair in the set of input-output pairs the input is provided to the base LLM and the base LLM generates an output in the input-output pair; and
training the second LLM based on the set of input-output pairs and the validation results to obtain the trained LLM.

3. The method of claim 2, wherein training the second LLM based on the based on the set of input-output pairs and the validation results to obtain the trained LLM comprises:
determining, for each input-output pair in the set of input-output pairs and using the validation results, whether the input-output pair is below a validation threshold;
when then input-output pair is below the validation threshold, generating a ground truth for the input-output pair, wherein training the second LLM is based on the input-output pair and the ground truth for the input-output pair; and
when the input-output pair is not below the validation threshold the training of the second LLM is based on the input-output pair.

4. The method of claim 3, wherein the ground truth for the input-output pair comprises a factually verifiable output corresponding to the input and is different than the output in the input-output pair.

5. The method of claim 2, wherein the second LLM has fewer parameters than the base LLM.

6. The method of claim 5, wherein the second LLM has at least five times less parameters than the base LLM.

7. The method of claim 1, wherein prior to deploying the trained LLM at least one computational path in the trained LLM is pruned, wherein the at least one pruned computational path is not associated with the target domain.

8. A non-transitory computer readable medium comprising computer readable program code, which when executed by a computer processor enables the computer processor to perform a method for processing queries, the method comprising:
obtaining a query from a client, wherein the query is associated with a target domain;
generating an intermediate result using a base Large Language Model (LLM);
providing the intermediate result and the query to a trained LLM, wherein the trained LLM is associated with the target domain and is trained using the base LLM;
generating, by the trained LLM, a final response based on the intermediate result and the query; and
providing the final response to the client.

9. The non-transitory computer readable medium of claim 8, further comprising:
prior to obtaining the query, training a second LLM using the base LLM to obtain the trained LLM, wherein training the second LLM comprises:
validating a set of input-output pairs to obtain validation results, wherein for each input in an input-output pair in the set of input-output pairs the input is provided to the base LLM and the base LLM generates an output in the input-output pair; and
training the second LLM based on the set of input-output pairs and the validation results to obtain the trained LLM.

10. The non-transitory computer readable medium of claim 9, wherein training the second LLM based on the based on the set of input-output pairs and the validation results to obtain the trained LLM comprises, further comprising:
determining, for each input-output pair in the set of input-output pairs and using the validation results, whether the input-output pair is below a validation threshold;
when the input-output pair is below the validation threshold, generating a ground truth for the input-output pair, wherein training the second LLM is based on the input-output pair and the ground truth for the input-output pair; and
when the input-output pair is not below the validation threshold the training of the second LLM is based on the input-output pair.

11. The non-transitory computer readable medium of claim 10, wherein the ground truth for the input-output pair comprises a factually verifiable output corresponding to the input and is different than the output in the input-output pair.

12. The non-transitory computer readable medium of claim 9, wherein the second LLM has fewer parameters than the base LLM.

13. The non-transitory computer readable medium of claim 12, wherein the second LLM has at least five times less parameters than the base LLM.

14. The non-transitory computer readable medium of claim 8, wherein prior to deploying the trained LLM at least one computational path in the trained LLM is pruned, wherein the at least one pruned computational path is not associated with the target domain.

15. A system for processing queries comprises:
a plurality of clients; and
a manager configured to:
obtain a query from a client, wherein the query is associated with a target domain;
generate an intermediate result using a base Large Language Model (LLM);
provide the intermediate result and the query to a trained LLM, wherein the trained LLM is associated with the target domain and is trained using the base LLM;
generate, by the trained LLM, a final response based on the intermediate result and the query; and
provide the final response to the client.

16. The system of claim 15, wherein the manager is further configured to:
prior to obtaining the query, train a second LLM using the base LLM to obtain the trained LLM, wherein training the second LLM comprises:
validating a set of input-output pairs to obtain validation results, wherein for each input in an input-output pair in the set of input-output pairs the input is provided to the base LLM and the base LLM generates an output in the input-output pair; and
training the second LLM based on the set of input-output pairs and the validation results to obtain the trained LLM.

17. The system of claim 16, wherein training the second LLM based on the based on the set of input-output pairs and the validation results to obtain the trained LLM comprises:
determining, for each input-output pair in the set of input-output pairs and using the validation results, whether the input-output pair is below a validation threshold;
when the input-output pair is below the validation threshold, generating a ground truth for the input-output pair, wherein training the second LLM is based on the input-output pair and the ground truth for the input-output pair; and
when the input-output pair is not below the validation threshold the training of the second LLM is based on the input-output pair.

18. The system of claim 17, wherein the ground truth for the input-output pair comprises a factually verifiable output corresponding to the input and is different than the output in the input-output pair.

19. The system of claim 16, wherein the second LLM has fewer parameters than the base LLM.

20. The system of claim 19, wherein the second LLM has at least five times less parameters than the base LLM.
